(19) United States
(12) Patent Application Publication
(10) Pub. No.: US 2017/0121543 A1
(43) Pub. Date: May 4, 2017

(54) INK, INK STORED CONTAINER, INKJET PRINTING METHOD, INKJET PRINTING APPARATUS, AND PRINTED MATTER

(71) Applicants: Hiromi SAKAGUCHI, Kanagawa (JP); Hiroshi Gotou, Shizuoka (JP); Yuuki Yokohama, Kanagawa (JP); Hideaki Nishimura, Kanagawa (JP); Kaori Toyama, Kanagawa (JP); Masayuki Fukuoka, Tokyo (JP)

(72) Inventors: Hiromi SAKAGUCHI, Kanagawa (JP); Hiroshi Gotou, Shizuoka (JP); Yuuki Yokohama, Kanagawa (JP); Hideaki Nishimura, Kanagawa (JP); Kaori Toyama, Kanagawa (JP); Masayuki Fukuoka, Tokyo (JP)

(21) Appl. No.: 15/279,036

(22) Filed: Sep. 28, 2016

(30) Foreign Application Priority Data
Nov. 4, 2015 (JP) 2015-216842
Apr. 13, 2016 (JP) 2016-080504

(51) Int. Cl. C09D 11/102; C09D 11/36; C09D 11/322; C09D 11/107

(52) U.S. Cl. CPC C09D 11/102; C09D 11/107; C09D 11/36; C09D 11/322

(57) ABSTRACT

Provided is an ink including: an organic solvent; water; a coloring material; a wax; and resin particles, wherein the resin particles include acrylic resin particles and urethane resin particles, and wherein a ratio by mass (urethane resin particles/acrylic resin particles) of a proportion (percent by mass) of the urethane resin particles to a proportion (percent by mass) of the acrylic resin particles is 0.1 or greater but 0.7 or less. In a preferable aspect, the wax is a polyethylene wax. In another preferable aspect, the urethane resin particles are polycarbonate urethane resin particles.

### CROSS-REFERENCE TO RELATED APPLICATIONS

The present application claims priority under 35 U.S.C. §119 to Japanese Patent Application No. 2015-216842, filed Nov. 4, 2015 and Japanese Patent Application No. 2016-080504, filed Apr. 13, 2016. The contents of which are incorporated herein by reference in their entirety.

### BACKGROUND OF THE INVENTION

Field of the Invention

The present disclosure relates to an ink, an ink stored container, an inkjet printing method, an inkjet printing apparatus, and a printed matter.

Description of the Related Art

Compared with other printing methods, inkjet printing methods have simple processes, can be easily accommodated to full-color operations, and can provide high-resolution images even when used on apparatuses having simple configurations. Therefore, the inkjet printing methods are spreading to personal and office use and commercial printing and industrial printing fields.

In the commercial printing field, coated paper such as coat paper and art paper is used in addition to plain paper as print media, and images need to have a high scratch resistance because printed matters are handled as products such as postcards and packages. Furthermore, a high productivity is needed with a short downtime during printing. In the case of the inkjet printing methods, discharging stability is also needed. However, inks having scratch resistance are likely to cause ink adherence in printing head units. Therefore, it has been difficult to satisfy both of scratch resistance and discharging stability.

Hence, there is proposed an inkjet printing method using a water-based ink composition including a water-insoluble colorant, resin particles, a silicone-based surfactant, an acetylene glycol-based surfactant, a pyrrolidone derivative, 1,2-alkyldiol, a polyol, and water, wherein the resin particles include resin-fixing particles and wax particles (see, e.g., Japanese Unexamined Patent Application Publication No. 2010-090266).

### SUMMARY OF THE INVENTION

According to one aspect of the present disclosure, there is provided an ink including an organic solvent, water, a coloring material, a wax, and resin particles. The resin particles include acrylic resin particles and urethane resin particles. A ratio by mass (urethane resin particles/acrylic resin particles) of a proportion (percent by mass) of the urethane resin particles to a proportion (percent by mass) of the acrylic resin particles is 0.1 or greater but 0.7 or less.

### BRIEF DESCRIPTION OF THE DRAWINGS

FIG. 1 is a perspective view illustrating an example of a serial-type image forming apparatus according to an embodiment of the present disclosure;

FIG. 2 is a perspective view illustrating an example of a main tank of the apparatus of FIG. 1; and

FIG. 3 is an exemplary graph illustrating an area A of a peak region and an area B of a peak region.

### DESCRIPTION OF THE EMBODIMENTS

An ink of the present disclosure includes an organic solvent, water, a coloring material, a wax, and resin particles. The resin particles include acrylic resin particles and urethane resin particles. A ratio by mass (urethane resin particles/acrylic resin particles) of a proportion (percent by mass) of the urethane resin particles to a proportion (percent by mass) of the acrylic resin particles is 0.1 or greater but 0.7 or less. The ink further includes other components as needed.

The ink of the present disclosure is based on a finding that it is difficult for existing inks to satisfy all of scratch resistance, discharging stability, and storage stability.

The present inventors also have obtained the following finding.

Inks including acrylic resin particles are excellent in discharging stability but tend to impart a low scratch resistance to obtained images because the acrylic resin particles are high in hardness and low in elasticity. As compared with this, inks including urethane resin particles tend to impart a high scratch resistance to obtained images because the urethane resin particles are lower in hardness and higher in elasticity than acrylic resin particles. Hence, it is expected that inks including acrylic resin particles and urethane resin particles will be improved in scratch resistance while also being ensured discharging stability.

However, there is a tendency that inks including urethane resin particles easily cause filming because of a high hydrogen bonding strength and generate adhered matters in printing head units, and that the inks have a poor discharging stability due to the adhered matters. In order for generation of adhered matters in the printing head units to be prevented, addition of urethane resin particles in a high amount is unavailable. This makes it impossible for obtained images to satisfy scratch resistance sufficiently.

It has also been known that obtained images can have an improved mechanical strength but have a high dynamic friction coefficient.

Here, addition of acrylic resin particles and urethane resin particles at a specific ratio by mass and further addition of a wax have resulted in findings that obtained images can be reduced in dynamic friction coefficient and can be provided with a good scratch resistance even though the proportion of the urethane resin particles is low, and that inks can be provided with excellent discharging stability and excellent storage stability.

An ink film formed using the ink of the present disclosure including an organic solvent, water, a coloring material, a wax, and resin particles, wherein the resin particles include acrylic resin particles and urethane resin particles, and wherein a ratio by mass (urethane resin particles/acrylic resin particles) of a proportion (percent by mass) of the urethane resin particles to a proportion (percent by mass) of the acrylic resin particles is 0.1 or greater but 0.7 or less gives an area ratio (B/A) of 0.3 or greater but 1.0 or less when measured according to a Fourier transform infrared spectroscopy method, where A in the area ratio (B/A) is an area of a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less, and B in the area ratio (B/A) is an area of a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less. Furthermore, an ink film in which the ink is attached in an amount of 1.12 mg/cm² has a dynamic friction coefficient of 0.4 or less.

The present disclosure has an object to provide an ink that is capable of forming an image having a good scratch resistance and is excellent in discharging stability and storage stability.

The present disclosure can provide an ink that is capable of forming an image having a good scratch resistance and is excellent in discharging stability and storage stability.

### <Ink>

The organic solvent, water, coloring material, resin, and additives for use in the ink are described next.

### <Resin Particles>

The resin particles include acrylic resin particles and urethane resin particles, and further include other resin particles as needed.

It is preferable that the resin particles be a water-dispersible dispersion.

Examples of the acrylic resin particles include acrylic silicone resin particles and styrene acrylic resin particles. One kind of these acrylic resin particles may be used alone or two or more kinds of these acrylic resin particles may be used in combination. Among these acrylic resin particles, acrylic silicone resin particles are preferable in terms of scratch resistance.

Examples of the urethane resin particles include polycarbonate urethane resin particles, polyester urethane resin particles, and polyether urethane resin particles. One kind of these urethane resin particles may be used alone or two or more kinds of these urethane resin particles may be used in combination. Among these urethane resin particles, polycarbonate urethane resin particles are preferable in terms of scratch resistance and storage stability. What is meant by polycarbonate urethane resin particles is that a polycarbonate structure is included in the structure, and polycarbonate urethane resin particles encompass also polycarbonate-based urethane resin particles.

The resin particles may be a commercially available product or a synthesized product. Examples of the commercially available product include: product name SYMAC (available from Toagosei Co., Ltd.), product name VONCOAT (available from DIC CORPORATION), and product name AQUABRID (available from Daicel Corporation) for acrylic resin particles; product name UCOAT (available from DKS Co., Ltd.) and product name TAKELAC (available from Mitsui Chemicals, Inc.) for urethane resin particles; and product name TAKELAC W-4000, product name TAKELAC W-6010, and product name TAKELAC W-6110 (all available from Mitsui Chemicals, Inc.) for polycarbonate urethane resin particles. One of these commercially available products may be used alone or two or more of these commercially available products may be used in combination.

Martens hardness of the resin particles is preferably 10 N/mm² or less in terms of scratch resistance.

Martens hardness of the urethane resin particles is preferably 10 N/mm² or less and more preferably 0.1 N/mm² or greater but 10 N/mm² or less in terms of scratch resistance.

Martens hardness can be measured by coating a support such as a glass slide (product name: white plate glass S1111 available from Matsunami Glass Ind., Ltd.) with a liquid of the resin particles to an average thickness of 10 μm or greater, predrying the coated support at 60 degrees C. for 3 hours, drying the coated support at 100 degrees C. for 6 hours to obtain a resin film, intending a Vickers indenter into the obtained resin film with a force of 1.0 mN for 10 seconds using a microhardness tester (instrument name: HM-2000 available from Fischer Instruments K.K.), and after retaining the Vickers indenter for 5 seconds, removing the Vickers indenter with a force of 1.0 mN in 10 seconds.

The volume average particle diameter of the resin particle is not particularly limited and can be suitably selected to suit to a particular application. The volume average particle diameter is preferably from 10 through 1,000 nm, more preferably from 10 through 200 nm, and furthermore preferably from 10 through 100 nm to obtain good fixability and a high image hardness.

The volume average particle diameter can be measured by using a particle size analyzer (Nanotrac Wave-UT151, manufactured by MicrotracBEL Corp.).

The particle diameter of the solid portion in ink has no particular limit and can be suitably selected to suit to a particular application. For example, the maximum frequency in the maximum number conversion is preferably from 20 through 1,000 nm and more preferably from 20 through 150 nm to ameliorate the discharging stability and image quality such as image density. The solid portion includes resin particles, particles of pigments, etc. The particle diameter of the solid portion can be measured by using a particle size analyzer (Nanotrac Wave-UT151, manufactured by MicrotracBEL Corp).

The proportion of the resin particles is preferably 1 percent by mass or greater but 30 percent by mass or less and more preferably 5 percent by mass or greater but 25 percent by mass or less of the total amount of the ink.

The proportion of the acrylic resin particles is preferably 5 percent by mass or greater but 30 percent by mass or less and more preferably 6 percent by mass or greater but 20 percent by mass or less of the total amount of the ink.

The proportion of the urethane resin particles is preferably 1 percent by mass or greater but 10 percent by mass or less and more preferably 1 percent by mass or greater but 4 percent by mass or less of the total amount of the ink.

### [Ratio by Mass (Urethane Resin Particles/Acrylic Resin Particles)]

The ratio by mass (urethane resin particles/acrylic resin particles) of the proportion (percent by mass) of the urethane resin particles to the proportion (percent by mass) of the acrylic resin particles is 0.1 or greater but 0.7 or less, and in terms of scratch resistance, discharging stability, and storage stability, preferably 0.4 or greater but 0.7 or less.

### <Wax>

The wax can reduce dynamic friction coefficient of surfaces of images (ink films). Particularly, when combined with the urethane resin particles, the wax can drastically improve scratch resistance of images. The drastic improvement of scratch resistance is considered possible because the wax can reduce impact that may be applied to images with capability of suppressing increase in dynamic friction coefficient due to the urethane resin particles added for improving scratch resistance of images, and because mechanical strength of the urethane resin particles is sufficiently exhibited.

The wax is preferably a water-dispersible wax emulsion.

Examples of the wax include polyethylene waxes and paraffin waxes. One of these waxes may be used alone or two or more of these waxes may be used in combination. Among these waxes, polyethylene waxes are preferable in terms of storage stability.

The wax may be a commercially available product. Examples of the commercially available product include product name HYTEC E-8237 (polyethylene wax, with a melting point of 106 degrees C. and an average particle diameter of 80 nm, available from Toho Chemical Industry Co., Ltd.), product name AQUACER 531 (polyethylene wax, with a melting point of 130 degrees C., available from Byk Chemie Japan Co., Ltd.), product name AQUACER 515 (polyethylene wax, with a melting point of 135 degrees C., available from Byk Chemie Japan Co., Ltd.), and product name AQUACER 537 (paraffin, with a melting point of 110 degrees C., available from Byk Chemie Japan Co., Ltd.). One of these commercially available products may be used alone or two or more of these commercially available products may be used in combination.

The melting point of the wax is preferably 70 degrees C. or higher but 170 degrees C. or lower and more preferably 100 degrees C. or higher but 140 degrees C. or lower. When the melting point of the wax is 70 degrees C. or higher, images are not sticky and do not transfer between the images even when the images are stacked. When the melting point of the wax is 170 degrees C. or lower, the wax melts with frictional heat generated when images are scratched and imparts slippage to provide the images with a good scratch resistance.

The volume average particle diameter of the wax is preferably 200 nm or less and more preferably 20 nm or greater but 150 nm or less. When the volume average particle diameter of the wax is 200 nm or less, the wax does not get stuck in nozzles or a filter in a head. This provides a good discharging stability.

The volume average particle diameter can be measured with, for example, a particle size analyzer (MICROTRAC MODEL UPA 9340 available from Nikkiso Co., Ltd.).

The proportion of the wax as expressed in a solid proportion is preferably 0.09 percent by mass or greater but 0.5 percent by mass or less of the total amount of the ink. When the solid concentration of the wax is 0.09 percent by mass or greater but 0.5 percent by mass or less, the wax is sufficiently effective for reducing the dynamic friction coefficient of surfaces of obtained images (ink films) and is less adversely influential to storage stability and discharging stability of the ink.

### <Organic Solvent>

There is no specific limitation on the type of the organic solvent used in the present disclosure. For example, water-soluble organic solvents are suitable. Specific examples thereof include, but are not limited to, polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

Since the water-soluble organic solvent serves as a humectant and also imparts a good drying property, it is preferable to use an organic solvent having a boiling point of 250 degrees C. or lower.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethylene glycol monomethylether, diethyleneglycol monoethylether, diethyleneglycol monobutylether, tetraethyleneglycol monomethylether, and propyleneglycol monoethylether; and polyol arylethers such as ethyleneglycol monophenylether and ethyleneglycol monobenzylether.

The polyol compounds having eight or more carbon atoms and glycolether compounds enhance the permeability of ink when paper is used as a print medium.

A total Hansen solubility parameter (hereinafter may also be referred to as “totHSP value”) of the organic solvent is preferably 20 MPa^{1/2} or greater but 23 MPa^{1/2} or less and more preferably 20.2 MPa^{1/2} or greater but 22.6 MPa^{1/2} or less. When the total Hansen solubility parameter of the organic solvent is 20 MPa^{1/2} or greater but 23 MPa^{1/2} or less, the organic solvent that is not easily compatibilized with the acrylic resin particles and the urethane resin particles because of having a different polarity comes to have a polarity close to polarities of both of the acrylic resin particles and the urethane resin particles and hence an improved compatibility with both of the acrylic resin particles and the urethane resin particles, to make it possible to provide a uniform ink. This also makes it possible to maintain a uniform dispersion state for a long time and improve storage stability of the ink.

The totHSP value is an indicator of solubility of a substance. The totHSP value is conceptually different from Hildebrand's SP value employed in, for example, ‘Solvent Handbook’ (Kodansha Scientific Ltd., published in 1976). The totHSP value represents solubility by multidimensional (typically, three-dimensional) vectors. Representatively, the vectors can be expressed by a dispersion term (δD), a polarity term (δP), and a hydrogen bond term (δH). The dispersion term (δD) reflects a Van der Waals force, the polarity term (δP) reflects a dipole moment, and the hydrogen bond term (δH) reflects an action of, for example, water or an alcohol. The totHSP value is the sum of the squares of the vectors ((δD)²+(δP)²+(δH)²).

The totHSP value can be calculated with software such as a product named HSPIP.

The dispersion term (δD) of the Hansen solubility parameter (hereinafter may also be referred to as “HSP value”) is preferably 15 MPa^{1/2} or greater but 18 MPa^{1/2} or less.

The polarity term (δP) of the HSP value is preferably 6 MPa^{1/2} or greater but 14 MPa^{1/2} or less and more preferably 6 MPa^{1/2} or greater but 11 MPa^{1/2} or less.

The hydrogen bond term (δH) of the HSP value is preferably 6 MPa^{1/2} or greater but 25 MPa^{1/2} or less and more preferably 6 MPa^{1/2} or greater but 13 MPa^{1/2} or less.

Examples of organic solvents having the totHSP value of 20 MPa^{1/2} or greater but 23 MPa^{1/2} or less include 3-butoxy-N,N-dimethylpropionamide (totHSP value: 20.2 MPa^{1/2}) represented by structural formula (1) below, 3-methoxy-N,N-dimethylpropionamide (totHSP value: 22.5 MPa^{1/2}) represented by structural formula (2) below, 3-ethyl-3-hydroxymethyloxetane (totHSP value: 22.6 MPa^{1/2}) represented by structural formula (3) below, propylene glycol monopropyl ether (totHSP value: 20.1 MPa^{1/2}), and propylene glycol monomethyl ether (totHSP value: 20.4 MPa^{1/2}). One of these organic solvents may be used alone or two or more of these organic solvents may be used in combination. Among these organic solvents, amide solvents such as 3-butoxy-N,N-dimethylpropionamide (totHSP value: 20.2 MPa^{1/2}) and 3-methoxy-N,N-dimethylpropionamide (totHSP value: 22.5 MPa^{1/2}) are preferable. Use of an amide solvent such as 3-butoxy-N,N-dimethylpropionamide and 3-methoxy-N,N-dimethylpropionamide in combination with the urethane resin particles promotes a filming property of the urethane resin particles and makes it possible for the urethane resin particles to express a higher scratch resistance. What is meant by amide solvent is that an amide structure is included in the structure, and amide solvent also encompasses the amides presented above.

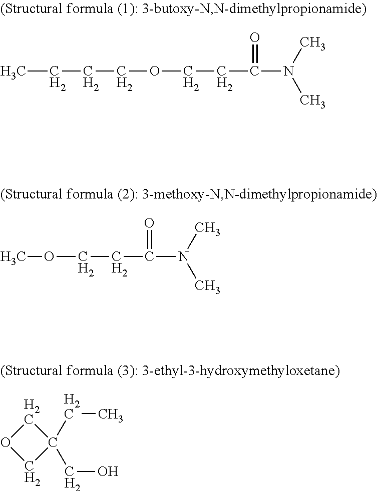

The proportion of the organic solvent in ink has no particular limit and can be suitably selected to suit a particular application. In terms of the drying property and discharging reliability of the ink, the proportion is preferably from 10 through 60 percent by mass and more preferably from 20 through 60 percent by mass.

The proportion of the amide solvent in the ink is preferably 0.05 percent by mass or greater but 10 percent by mass or less and more preferably 0.1 percent by mass or greater but 5 percent by mass or less.

### <Water>

The proportion of water in the ink has no particular limit and can be suitably selected to suit to a particular application. In terms of the drying property and discharging reliability of the ink, the proportion is preferably from 10 through 90 percent by mass and more preferably from 20 through 60 percent by mass.

The water is not particularly limited and may be appropriately selected depending on the intended purpose. Examples of the water include: pure water such as ion-exchanged water, ultrafiltrated water, reverse osmotic water, and distilled water; and ultrapure water. One of these kinds of water may be used alone or two or more of these kinds of water may be used in combination.

### <Coloring Material>

The coloring material has no particular limit. For example, pigments and dyes are suitable.

The pigment includes inorganic pigments and organic pigments. These can be used alone or in combination. In addition, it is possible to use a mixed crystal.

As the pigments, for example, black pigments, yellow pigments, magenta pigments, cyan pigments, white pigments, green pigments, orange pigments, gloss pigments of gold, silver, etc., and metallic pigments can be used.

As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63; C.I. Pigment Green 1, 4, 7, 8, 10, 17, 18, and 36.

The type of dye is not particularly limited and includes, for example, acidic dyes, direct dyes, reactive dyes, and basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 through 15 percent by mass and more preferably from 1 through 10 percent by mass in terms of enhancement of image density, fixability, and discharging stability.

To obtain the ink, the pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment to be added to ink is not necessarily wholly coated with resin. Pigments partially or wholly uncovered with resin may be dispersed in the ink unless the pigments have an adverse impact.

To use a dispersant, for example, a known dispersant of a small molecular weight type or a high molecular weight type represented by a surfactant is used to disperse the pigments in ink.

As the dispersant, it is possible to use, for example, anionic surfactants, cationic surfactants, amphoteric surfactants, nonionic surfactants, etc. depending on the pigments.

Also, a nonionic surfactant (RT-100, manufactured by TAKEMOTO OIL & FAT CO., LTD.) and a formalin condensate of naphthalene sodium sulfonate are suitable as dispersants.

These dispersants can be used alone or in combination.

### <Pigment Dispersion>

The ink can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by mixing and dispersing water, pigment, pigment dispersant, and other optional components and adjusting the particle diameter. It is good to use a dispersing device for dispersion.

The particle diameter of the pigment in the pigment dispersion has no particular limit. For example, the maximum frequency in the maximum number conversion is preferably from 20 through 500 nm and more preferably from 20 through 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the proportion is preferably from 0.1 through 50 percent by mass and more preferably from 0.1 through 30 percent by mass.

During the production, coarse particles are optionally filtered off from the pigment dispersion with a filter, a centrifuge, etc. preferably followed by degassing.

### [Ratio by Mass (Pigment Particles/Coloring Material)]

A ratio by mass (resin particles/coloring material) of the proportion (percent by mass) of the resin particles to the proportion (percent by mass) of the coloring material is preferably 0.5 or greater but 3.0 or less and more preferably 0.6 or greater but 3.0 or less in terms of scratch resistance and discharging stability.

### [Ratio by Mass (Amide Solvent/Urethane Resin Particles)]

A ratio by mass (amide solvent/urethane resin particles) of the proportion (percent by mass) of the amide solvent and to the proportion (percent by mass) of the urethane resin particles is preferably 0.1 or greater but 5.0 or less and more preferably 0.17 or greater but 4.2 or less. When the ratio by mass is 0.1 or greater, a filming effect is likely to be obtained. When the ratio by mass is 5.0 or less, the resin particles do not swell during storage of the ink. This makes viscosity change less likely to occur and improves storage stability.

### [Area Ratio (B/A)]

An ink film formed with the ink of the present disclosure gives an area ratio (B/A) of 0.3 or greater but 1.0 or less and preferably 0.6 or greater but 1.0 or less when measured according to a Fourier transform infrared spectroscopy method (hereinafter may also be referred to as “FTIR”), where the area ratio (B/A) is a ratio of an area B of a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less to an area A of a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less. When the area ratio (B/A) is 0.3 or greater but 1.0 or less, a scratch resistance improving effect of the urethane resin particles and a discharging stability improving effect of the acrylic resin particles can both be satisfied.

The Fourier transform infrared spectroscopic measurement of the ink film can use an attenuated total reflection (ATR) method of a Fourier transform infrared spectrophotometer. Specifically, a surface of an ink film formed on paper (product name: LUMI ART GLOSS 130 GSM available from Stora Enso Oyj) in a manner that the ink is attached in an amount of 1.12 mg/cm² (700 mg/A4) is measured with an instrument named SPECTRUM ONE (available from Perkin Elmer Co., Ltd.) according to the ATR method using a diamond indenter, and the area ratio can be determined from a spectrum obtained from the measurement.

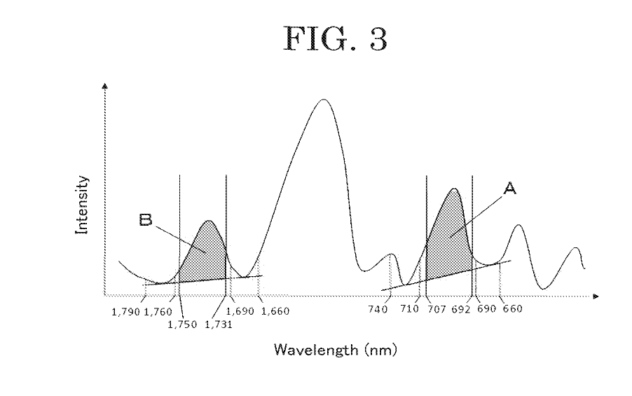

FIG. 3 is an exemplary graph illustrating the area A of a peak region and the area B of a peak region.

As illustrated in FIG. 3, the area A of a peak region can be calculated with an instrument named SPECTRUM ONE (available from Perkin Elmer Co., Ltd.) from a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less. The area B of a peak region can be calculated from a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less in the same manner as for the area A of a peak region.

### [Dynamic Friction Coefficient]

An ink film in which the ink is attached in an amount of 1.12 mg/cm² (700 mg/A4) has a dynamic friction coefficient of 0.4 or less. When the dynamic friction coefficient of the ink film is 0.4 or less, the ink film has an improved slippage and the image is less likely to be destroyed. This effect can be drastically improved when the urethane resin particles are combined with the wax.

The dynamic friction coefficient is measured by forming an ink film on a print medium (paper) in a manner that the ink is attached in an amount of 1.12 mg/cm² (700 mg/A4) in an environment having a temperature of 23 degrees C. and a humidity of 50 percent RH, overlapping the print medium (blank paper) with the image, and frictioning the blank paper against the image under a vertical load of 20 g/cm² at a speed of 1,200 mm/min for a length of 60 mm. The dynamic friction coefficient of the surface of the image is defined as a mean dynamic friction coefficient within a range of 30 mm or farther from but 50 mm or closer to the start position of frictioning.

The dynamic friction coefficient can be measured with an instrument HEIDON TYPE 14DR (available from Shinto Scientific Co., Ltd.). The print medium may be a product named LUMI ART GLOSS 130 GSM (available from Stora Enso Oyj).

The dynamic friction coefficient is greater than 0.4 when the wax not added but the acrylic resin particles and the urethane resin particles are used as fixing resins instead. However, with addition of the wax, the dynamic friction coefficient of a surface of an image (ink film) can be 0.4 or less.

### <Additive>

Ink may further optionally contain a surfactant, a defoaming agent, a preservative and fungicide, a corrosion inhibitor, a pH regulator, etc.

### <Surfactant>

Examples of the surfactant are silicone-based surfactants, fluorosurfactants, amphoteric surfactants, nonionic surfactants, anionic surfactants, etc.

The silicone-based surfactant has no specific limit and can be suitably selected to suit to a particular application. Among silicone-based surfactants, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl silooxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These fluoro surfactants are particularly preferable because these fluoro surfactants do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., etc., NIHON EMULSION Co., Ltd., Kyoeisha Chemical Co., Ltd., etc.

The polyether-modified silicone-based surfactant has no particular limit and can be suitably selected to suit to a particular application. Examples thereof include a compound in which the polyalkylene oxide structure represented by the following general formula S-1 is introduced into the side chain of the Si site of dimethyl polysiloxane.

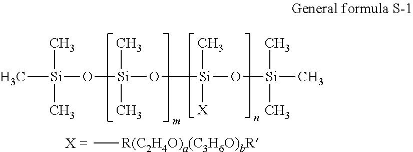

In general formula S-1, “m”, “n”, “a”, and “b” each, respectively represent integers, R represents an alkylene group, and R′ represents an alkyl group.

Products available on the market may be used as the polyether-modified silicone-based surfactants. Specific examples of the products available on the market include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by Byk Chemie Japan Co., Ltd.), and TSF4440, TSF4452, and TSF4453 (all manufactured by Toshiba Silicone Co., Ltd.).

A fluorosurfactant in which the number of carbon atoms replaced with fluorine atoms is from 2 through 16 and more preferably from 4 through 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these flurosurfactants, polyoxyalkylene ether polymer compounds having a perfluoroalkyl ether group in its side chain are preferable because these compounds do not foam easily and the fluorosurfactant represented by the following general formula F-1 or general formula F-2 is particularly preferable.

CF₃CF₂(CF₂CF₂)ₘ—CH₂CH₂O(CH₂CH₂O)ₙH General formula F-1

In general formula F-1, “m” is preferably an integer of from 0 through 10 and “n” is preferably an integer of from 0 through 40 in order to provide water solubility.

CₙF₂ₙ₊₁—CH₂CH(OH)CH₂—O—(CH₂CH₂O)ₐ—Y General formula F-2

In general formula F-2, Y represents H, CₙF₂ₙ₊₁, where “n” is an integer of from 1 through 6, CH₂CH(OH)CH₂—CₙF₂ₙ₊₁, where n represents an integer of from 4 through 6, or CₚH₂ₚ₊₁, where p represents an integer of from 1 through 19. “a” represents an integer of from 4 through 14.

Products available on the market may be used as the fluorosurfactant. Specific examples of the products available on the market include, but are not limited to, SURFLON S-111, SURFLON S-112, SURFLON-113, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFAC F-470, F-1405, and F-474 (all manufactured by DIC CORPORATION); ZONYL™ TBS, FSP, FSA, FSN-100, FSN, FSO-100, FSO, FS-300, UR, CAPSTONE® FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.), and UNIDYNE DSN-403N (manufactured by DAIKIN INDUSTRIES).

Of these products, FS-3100, FS-34, and FS-300 (all manufactured by The Chemours Company), FT-110, FT-250, FT-251, FT-400S, FT-150, and FT-400SW (all manufactured by NEOS COMPANY LIMITED), POLYFOX PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dyeing property to paper.

The proportion of the surfactant in ink is not particularly limited and can be suitably selected to suit to a particular application. It is preferably from 0.001 through 5 percent by mass and more preferably from 0.05 through 5 percent by mass in terms of excellent wettability and discharging stability and improvement on image quality.

### <Defoaming Agent>

The defoaming agent has no particular limit. For example, silicon-based defoaming agents, polyether-based defoaming agents, and aliphatic acid ester-based defoaming agents are suitable. These defoaming agents can be used alone or in combination. Of these defoaming agents, silicone-based defoaming agents are preferable to easily break foams.

### <Preservatives and Fungicides>

The preservatives and fungicides are not particularly limited. A specific example is 1,2-benzisothiazolin-3-on.

### <Corrosion Inhibitor>

The corrosion inhibitor has no particular limit. Examples thereof are acid sulfite and sodium thiosulfate.

### <pH Regulator>

The pH regulator has no particular limit. It is preferable to adjust the pH to 7 or higher. Specific examples thereof include, but are not limited to, amines such as diethanol amine and triethanol amine.

The property of the ink is not particularly limited and can be suitably selected to suit to a particular application. For example, viscosity, surface tension, pH, etc., are preferably in the following ranges.

The viscosity of the ink at 25 degrees C. is preferably from 5 through 30 mPa·s and more preferably from 5 through 25 mPa·s to improve print density and text quality and obtain good dischargeability. The viscosity can be measured by, for example, a rotatory viscometer (RE-80L, manufactured by TOKI SANGYO CO., LTD.). The measuring conditions are as follows:

Standard cone rotor (1° 34′× R24)

Sample liquid amount: 1.2 mL

Number of rotations: 50 rotations per minute (rpm)

25 degrees C.

Measuring time: three minutes

The surface tension of the ink is preferably 35 mN/m or less and more preferably 32 mN/m or less at 25 degrees C. in terms that the ink is suitably levelized on a print medium and the drying time of the ink is shortened.

The pH of the ink is preferably from 7 through 12 and more preferably from 8 through 11 in terms of prevention of corrosion of metal materials contacting the ink.

### <Method for Producing Ink>

As a method for producing the ink, for example, it is possible to produce the ink by stirring and mixing the water, the organic solvent, the resin particles, the coloring material, and the wax, and optionally the additives. For the stirring and mixing, for example, a sand mill, a homogenizer, a ball mill, a paint shaker, an ultrasonic disperser, a stirrer using a typical stirring blade, a magnetic stirrer, and a high-speed disperser can be used.

### <Print Medium>

The print medium for use in printing is not particularly limited. Specific examples thereof include, but are not limited to, plain paper, gloss paper, special paper, cloth, film, OHP sheets, printing paper for general purpose.

### <Printed Matter>

The printed matter of the present disclosure includes a print medium and an image formed on the print medium with the ink of the present disclosure.

An inkjet printing device and an inkjet printing method are used to print the image on the print medium to obtain the printed matter.

In the printed matter, an ink film including the organic solvent and the coloring material on the print medium gives an area ratio (B/A) of 0.3 or greater but 1.0 or less when measured according to a Fourier transform infrared spectroscopy method, where A in the area ratio (B/A) is an area A of a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less, and B in the area ratio (B/A) is an area of a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less. The ink film has a dynamic friction coefficient of 0.4 or less.

### <Ink Stored Container>

An ink stored container of the present disclosure includes the ink of the present disclosure and a container storing the ink, and further includes other members appropriately selected as needed.

The container is not particularly limited and may be of any shape, any structure, any size, any material, etc. that may be appropriately selected depending on the intended purpose. Preferable examples of the container include a container including at least, for example, an ink bag formed of, for example, aluminum laminate film or resin film.

### <Printing Device and Printing Method>

The ink of the present disclosure can be suitably applied to various printing devices employing an inkjet printing method such as printers, facsimile machines, photocopiers, multifunction peripherals (serving as a printer, a facsimile machine, and a photocopier), and 3D model manufacturing devices (3D printers, additive manufacturing device).

In the present disclosure, the printing device and the printing method represent a device capable of discharging ink, various processing fluids, etc. to a print medium and a method printing an image on the print medium using the device. The print medium means an article to which the ink or the various processing fluids can be attached at least temporarily.

The printing device may further optionally include a device relating to feeding, conveying, and ejecting the print medium and other devices referred to as a pre-processing device, a post-processing device, etc. in addition to the head portion to discharge the ink.

The printing device and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing.

In addition, the printing device and the printing method are not limited to those producing merely meaningful visible images such as texts and figures with the ink. For example, the printing device and the printing method can produce patterns like geometric design and 3D images.

In addition, the printing device includes both a serial type device in which the liquid discharging head is caused to move and a line type device in which the liquid discharging head is not moved, unless otherwise specified.

Furthermore, in addition to the desktop type, this printing device includes a wide type capable of printing images on a large print medium such as AO, a continuous printer capable of using continuous paper wound up in a roll form as print media.

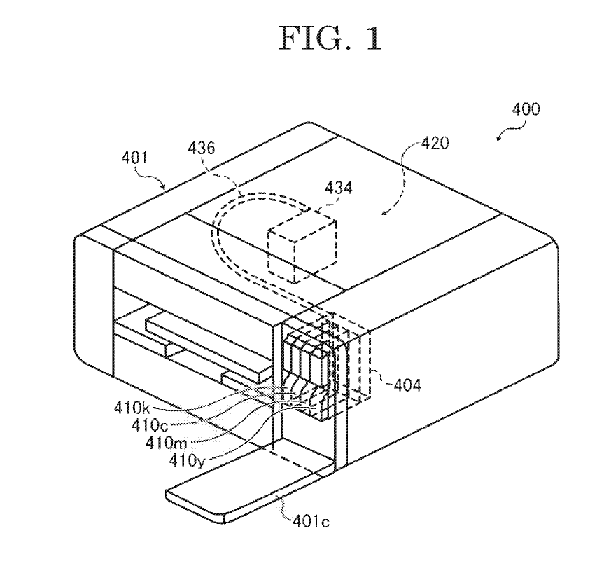

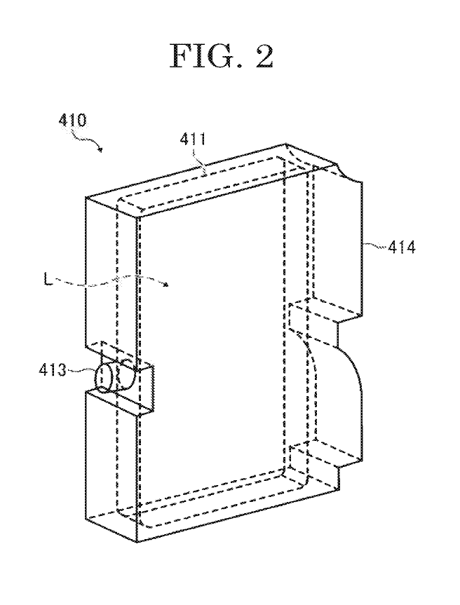

The printing device of the present disclosure is described using an example with reference to FIG. 1 and FIG. 2. FIG. 1 is a perspective view illustrating the image printing device. FIG. 2 is a perspective view illustrating the main tank. An image forming apparatus 400 as an example of the printing device is a serial type image forming apparatus. A mechanical unit 420 is disposed in an exterior 401 of the image forming apparatus 400. Each ink accommodating unit (ink container) 411 of each main tank 410 (410k, 410c, 410m, and 410y) for each color of black (K), cyan (C), magenta (M), and yellow (Y) is made of a packing member such as aluminum laminate film. The ink container 411 is accommodated in a plastic housing unit 414. As a result, the main tank 410 is used as an ink cartridge of each color.

A cartridge holder 404 is disposed on the rear side of the opening when a cover 401c is opened. The cartridge holder 404 is detachably attached to the main tank 410. As a result, each ink discharging outlet 413 of the main tank 410 is communicated with a discharging head 434 for each color via a supplying tube 436 for each color so that the ink can be discharged from the discharging head 434 to a print medium.

This printing device may include not only a portion discharging ink but also a device referred to as a pre-processing device, a post-processing device, etc.

As an example of the pre-processing device and the post-processing device, as in the case of the ink such as black (K), cyan (C), magenta (M), and yellow (Y), a liquid container containing a pre-processing fluid or a post-processing fluid and a liquid discharging head are added to discharge the pre-processing fluid or the post-processing fluid in an inkjet printing method.

As another example of the pre-processing device and the post-processing device, it is suitable to dispose a pre-processing device and a post-processing device employing a blade coating method, a roll coating method, or a spray coating method other than the inkjet printing method.

How to use the ink is not limited to the inkjet printing method. Specific examples of such methods other than the inkjet printing method include, but are not limited to, blade coating methods, gravure coating methods, bar coating methods, roll coating methods, dip coating methods, curtain coating methods, slide coating methods, die coating methods, and spray coating methods.

The applications of the ink of the present disclosure are not particularly limited and can be suitably selected to suit to a particular application. For example, the ink can be used for printed matter, a paint, a coating material, and foundation. The ink can be used to form two-dimensional texts and images and furthermore a three-dimensional solid object (3D modeling object) as a material for 3D modeling.

An apparatus for fabricating a three-dimensional object can be any known device with no particular limit. For example, the apparatus includes an ink container, a supplying device, and a discharging device, a drier, etc. The three-dimensional solid object includes an object manufactured by re-applying ink. In addition, the three-dimensional solid object can be manufactured by processing a structure having a substrate such as a print medium printed with the ink as a molded processed product. The molded processed product is fabricated by, for example, heating drawing or punching a structure or printed matter having a sheet-like form, film-like form, etc. The molded processed product is suitable for what is molded after surface-decorating. Examples thereof are gauges or operation panels of vehicles, office machines, electric and electronic machines, cameras, etc.

### EXAMPLES

The present disclosure will be described below more specifically by way of Examples. The present disclosure should not be construed as being limited to the Examples.

Martens hardness of urethane resin particles used in Examples and Comparative Examples described below and area ratio (B/A) and dynamic friction coefficient of ink films were measured in the manners described below.

### <Martens Hardness of Urethane Resin Particles>

Martens hardness of the urethane resin particles was measured by coating a glass slide (product name: white plate glass S1111 available from Matsunami Glass Ind., Ltd.) with a liquid of the urethane resin particles to an average thickness of 10 μm or greater, predrying the coated glass slide at 60 degrees C. for 3 hours, drying the coated glass slide at 100 degrees C. for 6 hours to obtain a resin film, intending a Vickers indenter into the obtained resin film with a force of 1.0 mN for 10 seconds using a microhardness tester (instrument name: HM-2000 available from Fischer Instruments K.K.), and after retaining the Vickers indenter for 5 seconds, removing the Vickers indenter with a force of 1.0 mN in 10 seconds.

### <Area Ratio (B/A)>

An ink film was formed on paper (product name: LUMI ART GLOSS 130 GSM available from Stora Enso Oyj) in a manner that an ink was attached in an amount of 1.12 mg/cm² (700 mg/A4). The ink film was measured according to an attenuated total reflection (ATR) method of a Fourier transform infrared spectrophotometer. The area ratio was determined from a spectrum obtained from the measurement. Specifically, the measurement was performed with an instrument named SPECTRUM ONE (available from Perkin Elmer Co., Ltd.) according to the ATR method using a diamond indenter, and the area ratio was determined from a spectrum obtained from the measurement.

### <Dynamic Friction Coefficient>

An ink film was formed on paper (product name: LUMI ART GLOSS 130 GSM available from Stora Enso Oyj) in a manner that the ink was attached in an amount of 1.12 mg/cm² (700 mg/A4) in an environment having a temperature of 23 degrees C. and a humidity of 50 percent RH. The paper (blank paper) was overlapped with the image and was frictioned against the image under a vertical load of 20 g/cm² at a speed of 1,200 mm/min for a length of 60 mm. A mean dynamic friction coefficient within a range of 30 mm or farther from but 50 mm or closer to the start position of frictioning was measured with an instrument: HEIDON TYPE 14DR (available from Shinto Scientific Co., Ltd.).

### (Production of Pigment Dispersion)

### <Production of Cyan Pigment Dispersion>

A cyan pigment dispersion was obtained in the same manner as a method described in Japanese Unexamined Patent Application Publication No 2012-207202, [Pigment surface reforming treatment],

### —Method A—.

Specifically, C.I. pigment blue 15:3 (product name: CHROMOFINE BLUE available from Dainichiseika Color & Chemicals Mfg. Co., Ltd.) (20 g), a compound represented by structural formula (5) below (20 mmol), and ion-exchanged water (200 mL) were mixed in a room temperature environment with a SILVERSON mixer (6,000 rpm (0.6 percent by mass)) to obtain a slurry. When it was the case that the obtained slurry had pH of higher than 4, nitric acid (20 mmol) was to be added to the slurry. Thirty minutes later, sodium nitrite (20 mmol) dissolved in a small amount of ion-exchanged water was slowly added to the slurry. Under stirring, the slurry was heated to 60 degrees C. and allowed to undergo a reaction for 1 hour, to obtain a reformed pigment in which the compound represented by structural formula (5) below was added to the surface of the C.I. pigment blue 15:3. Then, the reformed pigment was adjusted to pH of 10 with a NaOH aqueous solution, to obtain a reformed pigment dispersion thirty minutes later. The reformed pigment dispersion and ion-exchanged water were subjected to ultrafiltration through a dialysis membrane and further subjected to ultrasonic dispersion, to obtain a cyan pigment dispersion (self-dispersible type) having a pigment concentration of 15 percent by mass and including a bisphosphonic acid group as a hydrophilic functional group.

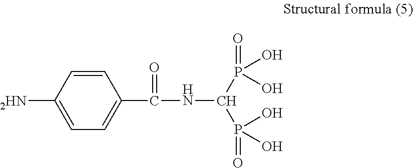

### (Production of Pigment Dispersion)

### <Production of Magenta Pigment Dispersion>

A magenta pigment dispersion having a pigment concentration of 15 percent by mass was produced in the same manner as the production of the cyan pigment dispersion, except that the C.I. pigment blue 15:3 (20 g) used in the production of the cyan pigment dispersion was changed to C.I. pigment red 122 (product name: TONER MAGENTA EO02 available from Clariant Japan Co., Ltd.) (20 g).

### (Production of Pigment Dispersion)

### <Production of Yellow Pigment Dispersion>

A yellow pigment dispersion having a pigment concentration of 15 percent by mass was produced in the same manner as the production of the cyan pigment dispersion, except that the C.I. pigment blue 15:3 (20 g) used in the production of the cyan pigment dispersion was changed to C.I. pigment yellow 74 (product name: FAST YELLOW 531 available from Dainichiseika Color & Chemicals Mfg. Co., Ltd.) (20 g).

### Example 1

The cyan pigment dispersion (15 percent by mass), 3-methoxy-N,N-dimethylpropionamide (available from Idemitsu Kosan Co., Ltd., with a totHSP value of 22.5 MPa^{1/2}) (5 percent by mass), 3-ethyl-3-hydroxymethyloxetane (available from Ube Industries, Ltd., with a totHSP value of 22.6 MPa^{1/2}) (30 percent by mass), an acrylic silicone resin particle liquid (with a solid concentration of 30 percent by mass) (6 percent by mass) containing acrylic silicone resin particles (product name: SYMAC US480, available from Toagosei Co., Ltd.), a polycarbonate urethane resin particles 1 liquid (with a solid concentration of 30 percent by mass) (4 percent by mass) containing polycarbonate urethane resin particles 1 (product name: TAKELAC W6110, available from Mitsui Chemicals, Inc., with a Martens hardness of 10 N/mm²), a polyethylene wax 1 liquid (with a solid concentration of 30 percent by mass) (1 percent by mass) containing a polyethylene wax 1 (product name: AQUACER 531, available from Byk Chemie Japan Co., Ltd., with a melting pint of 130 degrees C.), a polyether-modified siloxane copolymer (product name: TEGO WET 270 available from Tomoe Engineering Co., Ltd.) (2 percent by mass), and ion-exchanged water (balance) (total: 100 percent by mass) were mixed and stirred, and filtrated through a membrane filter (product name: DISMIC-25CS, available from Advantec) having an average pore diameter of 0.8 μm, to obtain an ink 1.

### Examples 2 to 18 and Comparative Examples 1 to 4

Inks 2 to 22 of Examples 2 to 18 and Comparative Examples 1 to 4 were produced in the same manner as in Example 1, except that the composition and proportions used in Example 1 were changed to the to composition and proportions presented in Tables 1 to 4.

TABLE 1

| | | | Examples | | | | | |
|---|---|---|---|---|---|---|---|---|
| | | | 1 | 2 | 3 | 4 | 5 | 6 |
| Coloring | Cyan pigment dispersion | | 15 | — | — | 15 | 15 | 15 |
| material | Magenta pigment dispersion | | — | 30 | — | — | — | — |
| | Yellow pigment dispersion | | — | — | 20 | — | — | — |
| Organic | Amide | 3-butoxy-N,N-dimethylpropionamide | — | — | — | — | — | — |
| solvent | solvent | (totHSP value: 20.2 MPa^{1/2}) | | | | | | |
| | | 3-methoxy-N,N-dimethylpropionamide | 5 | 3 | 3 | 0.2 | 5 | — |
| | | (totHSP value: 22.5 MPa^{1/2}) | | | | | | |
| | 3-ethyl-3-hydroxymethyloxetane | | 30 | 30 | 15 | 25 | — | 15 |
| | (totHSP value: 22.6 MPa^{1/2}) | | | | | | | |
| | Propylene glycol monomethyl ether | | — | — | — | — | 10 | — |
| | (totHSP value: 20.4 MPa^{1/2}) | | | | | | | |
| | Propylene glycol monopropyl ether | | — | — | — | — | — | — |
| | (totHSP value: 20.1 MPa^{1/2}) | | | | | | | |
| | 1,2-propanediol (totHSP value: 29.1 MPa^{1/2}) | | — | — | 15 | — | 10 | — |
| | 1,3-propanediol (totHSP value: 31.7 MPa^{1/2}) | | — | — | — | — | — | 15 |
| Resin | Acrylic | Acrylic silicone resin particle liquid | 6 | 6 | 6 | 6 | 7 | 9 |
| particles | resin | Styrene acrylic resin particle liquid | — | — | — | — | — | — |
| | particles | | | | | | | |
| | Urethane | Polycarbonate urethane resin | 4 | 4 | 4 | 4 | 3 | 1 |
| | resin | particle 1 liquid | | | | | | |
| | particles | Polycarbonate urethane resin | — | — | — | — | — | — |
| | | particle 2 liquid | | | | | | |
| | | Polycarbonate urethane resin | — | — | — | — | — | — |
| | | particle 3 liquid | | | | | | |
| | | Polyester urethane resin | — | — | — | — | — | — |
| | | particle liquid | | | | | | |
| | | Polyether urethane resin | — | — | — | — | — | — |
| | | particle liquid | | | | | | |

| | | | | | | | |
|---|---|---|---|---|---|---|---|
| Wax | Polyethylene wax 1 liquid | 1 | 1 | 0.3 | — | 1 | 1.5 |
| | Polyethylene wax 2 liquid | — | — | — | 1 | — | — |
| | Paraffin wax liquid | — | — | — | — | — | — |
| Surfactant | Polyether-modified siloxane copolymer | 2 | 2 | 2 | 2 | 2 | 2 |
| Water | Ion-exchanged water | balance | balance | balance | balance | balance | balance |

| | | | | | | |
|---|---|---|---|---|---|---|
| Total (percent by mass) | 100 | 100 | 100 | 100 | 100 | 100 |
| Area ratio (B/A) | 0.92 | 0.93 | 0.96 | 0.92 | 0.68 | 0.31 |
| Dynamic friction coefficient | 0.37 | 0.30 | 0.39 | 0.37 | 0.34 | 0.33 |
| Ratio by mass | 0.67 | 0.67 | 0.67 | 0.67 | 0.43 | 0.11 |
| (urethane resin particles/acrylic resin particles) | | | | | | |
| Martens hardness (N/mm²) of urethane resin particles | 10 | 10 | 10 | 10 | 10 | 10 |
| Ratio by mass (resin particles/coloring material) | 1.33 | 0.67 | 1.00 | 1.33 | 1.33 | 1.33 |
| Solid proportion (percent by mass) of wax | 0.30 | 0.30 | 0.09 | 0.30 | 0.30 | 0.45 |
| Ratio by mass (amide solvent/urethane resin particles) | 4.17 | 2.50 | 2.50 | 0.17 | 5.56 | — |

TABLE 2

| | | | Examples | | | | | |
|---|---|---|---|---|---|---|---|---|
| | | | 7 | 8 | 9 | 10 | 11 | 12 |
| Coloring | Cyan pigment dispersion | | 15 | 15 | — | 15 | 15 | 15 |
| material | Magenta pigment dispersion | | — | — | 40 | — | — | — |
| | Yellow pigment dispersion | | — | — | — | — | — | — |
| Organic | Amide | 3-butoxy-N,N-dimethylpropionamide | — | 0.1 | — | — | — | — |
| solvent | solvent | (totHSP value: 20.2 MPa^{1/2}) | | | | | | |
| | | 3-methoxy-N,N-dimethylpropionamide | — | — | — | 3 | 3 | 5 |
| | | (totHSP value: 22.5 MPa^{1/2}) | | | | | | |
| | 3-ethyl-3-hydroxymethyloxetane | | — | 15 | 20 | 30 | 30 | 30 |
| | (totHSP value: 22.6 MPa^{1/2}) | | | | | | | |
| | Propylene glycol monomethyl ether | | — | — | — | — | — | — |
| | (totHSP value: 20.4 MPa^{1/2}) | | | | | | | |
| | Propylene glycol monopropyl ether | | — | — | — | — | — | — |
| | (totHSP value: 20.1 MPa^{1/2}) | | | | | | | |
| | 1,2-propanediol (totHSP value: 29.1 MPa^{1/2}) | | — | — | — | — | — | — |
| | 1,3-propanediol (totHSP value: 31.7 MPa^{1/2}) | | 30 | 15 | — | — | — | — |
| Resin | Acrylic | Acrylic silicone resin particle liquid | 7 | 7 | 6 | 20 | — | 6 |
| particles | resin | Styrene acrylic resin particle liquid | — | — | — | — | 6 | — |
| | particles | | | | | | | |
| | Urethane | Polycarbonate urethane resin | 3 | 3 | 3 | 4 | 4 | — |
| | resin | particle 1 liquid | | | | | | |
| | particles | Polycarbonate urethane resin | — | — | — | — | — | 4 |
| | | particle 2 liquid | | | | | | |
| | | Polycarbonate urethane resin | — | — | — | — | — | — |
| | | particle 3 liquid | | | | | | |
| | | Polyester urethane resin | — | — | — | — | — | — |
| | | particle liquid | | | | | | |
| | | Polyether urethane resin | — | — | — | — | — | — |
| | | particle liquid | | | | | | |

| | | | | | | | |
|---|---|---|---|---|---|---|---|
| Wax | Polyethylene wax 1 liquid | 1 | 2 | 1 | 1 | 1 | 1 |
| | Polyethylene wax 2 liquid | — | — | — | — | — | — |
| | Paraffin wax liquid | — | — | — | — | — | — |
| Surfactant | Polyether-modified siloxane copolymer | 2 | 2 | 2 | 2 | 2 | 2 |
| Water | Ion-exchanged water | balance | balance | balance | balance | balance | balance |

| | | | | | | |
|---|---|---|---|---|---|---|
| Total (percent by mass) | 100 | 100 | 100 | 100 | 100 | 100 |
| Area ratio (B/A) | 0.69 | 0.72 | 0.75 | 0.51 | 0.93 | 0.90 |
| Dynamic friction coefficient | 0.29 | 0.28 | 0.36 | 0.37 | 0.35 | 0.34 |
| Ratio by mass | 0.43 | 0.43 | 0.50 | 0.20 | 0.67 | 0.67 |
| (urethane resin particles/acrylic resin particles) | | | | | | |
| Martens hardness (N/mm²) of urethane resin particles | 10 | 10 | 10 | 10 | 10 | 20 |
| Ratio by mass (resin particles/coloring material) | 1.33 | 1.33 | 0.45 | 3.20 | 1.33 | 1.33 |
| Solid proportion (percent by mass) of wax | 0.30 | 0.60 | 0.30 | 0.30 | 0.30 | 0.30 |
| Ratio by mass (amide solvent/urethane resin particles) | — | 0.11 | — | 2.50 | 2.50 | 4.17 |

TABLE 3

| | | | Examples | | | | | |
|---|---|---|---|---|---|---|---|---|
| | | | 13 | 14 | 15 | 16 | 17 | 18 |
| Coloring | Cyan pigment dispersion | | 15 | 15 | 15 | 15 | 15 | 15 |
| material | Magenta pigment dispersion | | — | — | — | — | — | — |
| | Yellow pigment dispersion | | — | — | — | — | — | — |
| Organic | Amide | 3-butoxy-N,N-dimethylpropionamide | — | — | — | — | — | — |
| solvent | solvent | (totHSP value: 20.2 MPa^{1/2}) | | | | | | |
| | | 3-methoxy-N,N-dimethylpropionamide | 5 | — | — | 5 | — | 5 |
| | | (totHSP value: 22.5 MPa^{1/2}) | | | | | | |
| | 3-ethyl-3-hydroxymethyloxetane | | 30 | 30 | 30 | 30 | 30 | — |
| | (totHSP value: 22.6 MPa^{1/2}) | | | | | | | |
| | Propylene glycol monomethyl ether | | — | — | — | — | — | — |
| | (totHSP value: 20.4 MPa^{1/2}) | | | | | | | |
| | Propylene glycol monopropyl ether | | — | — | — | — | — | 10 |
| | (totHSP value: 20.1 MPa^{1/2}) | | | | | | | |
| | 1,2-propanediol (totHSP value: 29.1 MPa^{1/2}) | | — | — | — | — | — | 10 |
| | 1,3-propanediol (totHSP value: 31.7 MPa^{1/2}) | | | | | | | |
| Resin | Acrylic | Acrylic silicone resin particle liquid | 6 | 6 | 6 | 6 | 6 | 7 |
| particles | resin | Styrene acrylic resin particle liquid | — | — | — | — | — | — |
| | particles | | | | | | | |
| | Urethane | Polycarbonate urethane resin | — | — | — | 4 | — | 3 |
| | resin | particle 1 liquid | | | | | | |
| | particles | Polycarbonate urethane resin | — | — | — | — | — | — |
| | | particle 2 liquid | | | | | | |
| | | Polycarbonate urethane resin | 4 | — | — | — | — | — |
| | | particle 3 liquid | | | | | | |
| | | Polyester urethane resin | — | 4 | — | — | — | — |
| | | particle liquid | | | | | | |
| | | Polyether urethane resin | — | — | 4 | — | 4 | — |
| | | particle liquid | | | | | | |

| | | | | | | | |
|---|---|---|---|---|---|---|---|
| Wax | Polyethylene wax 1 liquid | 1 | 1 | 1 | — | 0.2 | 1 |
| | Polyethylene wax 2 liquid | — | — | — | — | — | — |
| | Paraffin wax liquid | — | — | — | 1 | — | — |
| Surfactant | Polyether-modified siloxane copolymer | 2 | 2 | 2 | 2 | 2 | 2 |
| Water | Ion-exchanged water | balance | balance | balance | balance | balance | balance |

| | | | | | | |
|---|---|---|---|---|---|---|
| Total (percent by mass) | 100 | 100 | 100 | 100 | 100 | 100 |
| Area ratio (B/A) | 0.90 | 0.89 | 0.91 | 0.90 | 0.91 | 0.68 |
| Dynamic friction coefficient | 0.34 | 0.36 | 0.33 | 0.36 | 0.33 | 0.34 |
| Ratio by mass | 0.67 | 0.67 | 0.67 | 0.67 | 0.67 | 0.43 |
| (urethane resin particles/acrylic resin particles) | | | | | | |
| Martens hardness (N/mm²) of urethane resin particles | 15 | 1 | 5 | 10 | 5 | 10 |
| Ratio by mass (resin particles/coloring material) | 1.33 | 1.33 | 1.33 | 1.33 | 1.33 | 1.33 |
| Solid proportion (percent by mass) of wax | 0.30 | 0.30 | 0.30 | 0.30 | 0.06 | 0.30 |
| Ratio by mass (amide solvent/urethane resin particles) | 4.17 | — | — | 4.17 | — | 5.56 |

TABLE 4

| | | | Comparative Examples | | | |
|---|---|---|---|---|---|---|
| | | | 1 | 2 | 3 | 4 |
| Coloring | Cyan pigment dispersion | | 15 | 15 | 15 | 15 |
| material | Magenta pigment dispersion | | — | — | — | — |
| | Yellow pigment dispersion | | — | — | — | — |
| Organic | Amide | 3-butoxy-N,N-dimethylpropionamide | — | — | — | — |
| solvent | solvent | (totHSP value: 20.2 MPa^{1/2}) | | | | |
| | | 3-methoxy-N,N-dimethylpropionamide | 5 | 5 | 5 | 5 |
| | | (totHSP value: 22.5 MPa^{1/2}) | | | | |
| | 3-ethyl-3-hydroxymethyloxetane | | 30 | 30 | 30 | 30 |
| | (totHSP value: 22.6 MPa^{1/2}) | | | | | |
| | Propylene glycol monomethyl ether | | — | — | — | — |
| | (totHSP value: 20.4 MPa^{1/2}) | | | | | |
| | Propylene glycol monopropyl ether | | — | — | — | — |
| | (totHSP value: 20.1 MPa^{1/2}) | | | | | |
| | 1,2-propanediol (totHSP value: 29.1 MPa^{1/2}) | | — | — | — | — |
| | 1,3-propanediol (totHSP value: 31.7 MPa^{1/2}) | | — | — | — | — |
| Resin | Acrylic | Acrylic silicone resin particle liquid | 10 | 6 | 5 | 9.5 |
| particles | resin | Styrene acrylic resin particle liquid | — | — | — | — |
| | particles | | | | | |
| | Urethane | Polycarbonate urethane resin | — | — | — | — |
| | resin | particle 1 liquid | | | | |
| | particles | Polycarbonate urethane resin | — | — | — | — |
| | | particle 2 liquid | | | | |
| | | Polycarbonate urethane resin | — | — | — | — |
| | | particle 3 liquid | | | | |
| | | Polyester urethane resin | — | 4 | 5 | 0.5 |
| | | particle liquid | | | | |
| | | Polyether urethane resin | — | — | — | — |
| | | particle liquid | | | | |

| | | | | | |
|---|---|---|---|---|---|
| Wax | Polyethylene wax 1 liquid | 1 | — | 1 | 1 |
| | Polyethylene wax 2 liquid | — | — | — | — |
| | Paraffin wax liquid | — | — | — | — |
| Surfactant | Polyether-modified siloxane copolymer | 2 | 2 | 2 | 2 |
| Water | Ion-exchanged water | balance | balance | balance | balance |

| | | | | |
|---|---|---|---|---|
| Total (percent by mass) | 100 | 100 | 100 | 100 |
| Area ratio (B/A) | 0.13 | 0.91 | 1.20 | 0.20 |
| Dynamic friction coefficient | 0.36 | 0.46 | 0.38 | 0.35 |
| Ratio by mass | — | 0.67 | 1.00 | 0.05 |
| (urethane resin particles/acrylic resin particles) | | | | |
| Martens hardness (N/mm²) of urethane resin particles | — | 10 | 10 | 10 |
| Ratio by mass(resin particles/coloring material) | 1.33 | 1.33 | 1.33 | 1.33 |
| Solid proportion (percent by mass) of wax | 0.30 | — | 0.30 | 0.30 |
| Ratio by mass (amide solvent/urethane resin particles) | — | 4.17 | 3.33 | 33.33 |

Product names and supplier names of the components presented in Tables 1 to 4 are as follows.

### <Organic Solvent>

3-Butoxy-N,N-dimethylpropionamide (product name: EQUAMIDE B100, available from Idemitsu Kosan Co., Ltd., with a totHSP value of 20.2 MPa^{1/2})
3-Methoxy-N,N-dimethylpropionamide (product name: EQUAMIDE M100, available from Idemitsu Kosan Co., Ltd., with a totHSP value of 22.5 MPa^{1/2})
3-Ethyl-3-hydroxymethyloxetane (product name: EHO, available from Ube Industries, Ltd., with a totHSP value of 22.6 MPa^{1/2})
Propylene glycol monomethyl ether (product name: 1-methoxy-2-propanol, available from Tokyo Chemical Industry Co., Ltd., with a totHSP value of 20.4 MPa^{1/2})
Propylene glycol monopropyl ether (product name: 1-propoxy-2-propanol, available from Tokyo Chemical Industry Co., Ltd., with a totHSP value of 20.1 MPa^{1/2})
1,2-Propanediol (product name: Industrial propylene glycol, available from ADEKA Corporation, with a totHSP value of 29.1 MPa^{1/2})
1,3-Propanediol (product name: SUSTENA propanediol, available from Du Pont Kabushiki Kaisha, with a totHSP value of 31.7 MPa^{1/2})

### <Resin Particles>

### <<Acrylic Resin Particles>>

Acrylic silicone resin particles: available from Toagosei Co., Ltd., product name: SYMAC US480
Styrene acrylic resin particles: available from Showa Denko K.K., product name: POLYSOL AP-1120

### <<Urethane Resin Particles>>

Polycarbonate urethane resin particles 1: available from Mitsui Chemicals, Inc., product name: TAKELAC W6110, with a Martens hardness of 10 N/mm²
Polycarbonate urethane resin particles 2: available from Mitsui Chemicals, Inc., product name: TAKELAC WS4000, with a Martens hardness of 20 N/mm²
Polycarbonate urethane resin particles 3: available from Mitsui Chemicals, Inc., product name: TAKELAC W6061, with a Martens hardness of 15 N/mm²
Polyester urethane resin particles: available from Mitsui Chemicals, Inc., product name: TAKELAC WS5984, with a Martens hardness of 1 N/mm²
Polyether urethane resin particles: available from Mitsui Chemicals, Inc., product name: TAKELAC W5661, with a Martens hardness of 5 N/mm²

The resin particles were added after diluted with ion-exchanged water to a solid concentration of 30 percent by mass.

### <Wax>

Polyethylene wax 1: available from Byk Chemie Japan Co., Ltd., product name: AQUACER 531, with a melting point of 130 degrees C.
Polyethylene wax 2: available from Byk Chemie Japan Co., Ltd., product name: AQUACER 515, with a melting point of 135 degrees C.
Paraffin wax: available from Byk Chemie Japan Co., Ltd., product name: AQUACER 537, with a melting point of 110 degrees C.

The waxes were added after diluted with ion-exchanged water to a solid concentration of 30 percent by mass.

Next, using the inks, “scratch resistance”, “discharging stability”, and “storage stability” were evaluated in the manners described below. The results are presented in Table 5.

### <Scratch Resistance>

An inkjet printer (apparatus name: IPSIO GX5500, available from Ricoh Company, Ltd.) was loaded with each ink. Next, paper (product name: LUMI ART GLOSS 130 GSM, available from Stora Enso Oyj) was set in the inkjet printer, and a solid image (ink film) was printed in a manner that the ink was attached in an amount of 1.12 mg/cm² (700 mg/A4) and the resolution was 1,200 dpi×1,200 dpi. The solid image was dried at 100 degrees C. for 1 minute, and then the solid portion was scratched 20 times under a load of 400 g with the paper (product name: LUMI ART GLOSS 130 GSM, available from Stora Enso Oyj) cut into a size of 1.2 cm on all sides. Stains on the paper by ink attachment were measured with an instrument named reflective color spectrophotometric densitometer (available from X-Rite Inc.). The density of the stains was calculated by subtracting the background color of the scratching paper, and “scratch resistance” was evaluated according to the criteria described below. A grade of C or greater is a tolerable level.

### —Evaluation Criteria—

AA: The density was less than 0.05.

A: The density was 0.05 or greater but less than 0.10.

B: The density was 0.10 or greater but less than 0.15.

C: The density was 0.15 or greater but less than 0.20.

D: The density was 0.20 or greater.

### <Discharging Stability>

The inkjet printer mentioned above was loaded with each ink, left to stand still in a decapped state in a thermostat bath of 40 degrees C. for 24 hours, and then taken out. Head refreshing was performed via the printer driver, and “discharging stability” was evaluated according to the evaluation criteria described below. A grade of C or greater is a tolerable level.

### —Evaluation Criteria—

A: The ink was discharged from all nozzles with less than 4 times of head refreshing.

B: The ink was discharged from all nozzles with more than or equal to 4 times but less than 7 times of head refreshing.

C: The ink was discharged from all nozzles with more than or equal to 7 times but less than 10 times of head refreshing.

D: The ink was discharged from all nozzles with more than or equal to 10 times of head refreshing.

### <Storage Stability>

A 1.1 mL sample of each ink was taken and poured into a sample cup of a viscometer. The sample cup was set in the body of a rotary viscometer and left to stand still for 1 minute. After this, the rotor of the rotary viscometer was rotated, and a value appearing 1 minute later was read. The rotation number in the viscosity measurement was adjusted in a manner that torque would be constant in a range of 40 percent or higher but 80 percent or lower. The measurement was performed on the day after the ink was produced (initial viscosity), and after storage at 23 degrees C. for 1 week (viscosity after storage). These viscosity values were assigned in the formula described below to calculate a viscosity change rate, and “storage stability” was evaluated according to the evaluation criteria described below. A grade of C or greater is a tolerable level. The viscosity measurement was performed with a rotary viscometer (instrument name: RE80L, cone-plate type, available from Toki Sangyo Co., Ltd.) at 25 degrees C.

Viscosity change rate (percent)=[(viscosity after storage-initial viscosity)/initial viscosity]×100

### —Evaluation Criteria—

A: The viscosity change rate was lower than 1 percent.

B: The viscosity change rate was 1 percent or higher but lower than 3 percent.

C: The viscosity change rate was 3 percent or higher but lower than 5 percent.

D: The viscosity change rate was 5 percent or higher.

TABLE 5

| | | Evaluation results | | |
|---|---|---|---|---|
| | | Scratch | Discharging | Storage |
| | | resistance | stability | stability |
| Examples | 1 | AA | A | A |
| | 2 | AA | A | A |
| | 3 | AA | A | A |
| | 4 | AA | A | A |
| | 5 | AA | A | B |
| | 6 | A | A | A |
| | 7 | B | A | C |
| | 8 | AA | B | C |
| | 9 | B | A | A |
| | 10 | AA | C | A |
| | 11 | B | A | A |
| | 12 | C | A | A |
| | 13 | B | A | A |
| | 14 | A | A | C |
| | 15 | A | A | C |
| | 16 | B | A | C |
| | 17 | C | A | C |
| | 18 | AA | A | A |
| Comparative | 1 | D | A | A |
| Examples | 2 | D | A | D |
| | 3 | A | D | D |
| | 4 | D | A | A |

Aspects of the present disclosure are as follows, for example.

<1> An ink including:
an organic solvent;
water;
a coloring material;
s a wax; and
resin particles,
wherein the resin particles include acrylic resin particles and urethane resin particles, and
wherein a ratio by mass (the urethane resin particles/the acrylic resin particles) of a proportion (percent by mass) of the urethane resin particles to a proportion (percent by mass) of the acrylic resin particles is 0.1 or greater but 0.7 or less.
<2> The ink according to <1>,
wherein the wax is a polyethylene wax.
<3> The ink according to <1> or <2>,
wherein the urethane resin particles are polycarbonate urethane resin particles.
<4> The ink according to any one of <1> to <3>,
wherein the urethane resin particles have a Martens hardness of 10 N/mm² or less.
<5> The ink according to any one of <1> to <4>,
wherein the acrylic resin particles are acrylic silicone resin particles.
<6> The ink according to any one of <1> to <5>,
wherein a ratio by mass (the resin particles/the coloring material) of a proportion (percent by mass) of the resin particles to a proportion (percent by mass) of the coloring material is 0.5 or greater but 3.0 or less.
<7> The ink according to any one of <1> to <6>,
wherein a proportion of the wax as expressed in a solid proportion is 0.09 percent by mass or greater but 0.5 percent by mass or less.
<8> The ink according to any one of <1> to <7>,
wherein a total Hansen solubility parameter of the organic solvent is 20 MPa^{1/2} or greater but 23 MPa^{1/2} or less.
<9> The ink according to any one of <1> to <8>,
wherein the organic solvent is at least one selected from the group consisting of 3-butoxy-N,N-dimethylpropionamide, 3-methoxy-N,N-dimethylpropionamide, 3-ethyl-3-hydroxymethyloxetane, propylene glycol monopropyl ether, and propylene glycol monomethyl ether.
<10> The ink according to <9>,
wherein the organic solvent includes an amide solvent which is at least one of 3-butoxy-N,N-dimethylpropionamide and
3-methoxy-N,N-dimethylpropionamide, and
wherein a ratio by mass (the amide solvent/the urethane resin particles) of a proportion (percent by mass) of the amide solvent to the proportion (percent by mass) of the urethane resin particles is 0.1 or greater but 5.0 or less.
<11> The ink according to any one of <1> to <10>,
wherein the resin particles have a volume average particle diameter of 10 nm or greater but 1,000 nm or less.
<12> The ink according to any one of <1> to <11>,
wherein the proportion of the acrylic resin particles is 6 percent by mass or greater but 20 percent by mass or less.
<13> The ink according to any one of <1> to <12>,
wherein the proportion of the urethane resin particles is 1 percent by mass or greater but 4 percent by mass or less.
<14> The ink according to any one of <1> to <13>,
wherein a proportion of the organic solvent is 10 percent by mass or greater but 60 percent by mass or less.
<15> The ink according to any one of <1> to <14>,
wherein a proportion of the coloring material is 1 percent by mass or greater but 15 percent by mass or less.
<16> An ink including:
an organic solvent;
water; and
a coloring material,
wherein an ink film formed with the ink gives an area ratio (B/A) of 0.3 or greater but 1.0 or less when measured according to a Fourier transform infrared spectroscopy method, where A in the area ratio (B/A) is an area of a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less, and B in the area ratio (B/A) is an area of a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less, and
wherein an ink film in which the ink is attached in an amount of 1.12 mg/cm² has a dynamic friction coefficient of 0.4 or less.
<17> An ink stored container including:
the ink according to any one of <1> to <16>; and
a container storing the ink.
<18> An inkjet printing method including
an ink discharging step of applying a stimulus to the ink according to any one of <1> to <16> to discharge the ink to print an image on a print medium.
<19> An inkjet printing apparatus including
an ink discharging unit configured to apply a stimulus to the ink according to any one of <1> to <16> to discharge the ink to print an image on a print medium.
<20> A printed matter including:
a print medium; and
an ink film on the print medium,
the ink film including an organic solvent and a coloring material,
wherein the ink film gives an area ratio (B/A) of 0.3 or greater but 1.0 or less when measured according to a Fourier transform infrared spectroscopy method, where A in the area ratio (B/A) is an area of a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less, and B in the area ratio (B/A) is an area of a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less, and
wherein the ink film has a dynamic friction coefficient of 0.4 or less.

The ink according to any one of <1> to <16>, the ink stored container according to <17>, the inkjet printing method according to <18>, the inkjet printing apparatus according to <19>, and the printed matter according to <20> can solve the various problems of the related art and achieve the object of the present disclosure.

What is claimed is:

1. An ink comprising:
an organic solvent;
water;
a coloring material;
a wax; and
resin particles,
wherein the resin particles comprise acrylic resin particles and urethane resin particles, and
to wherein a ratio by mass (the urethane resin particles/the acrylic resin particles) of a proportion (percent by mass) of the urethane resin particles to a proportion (percent by mass) of the acrylic resin particles is 0.1 or greater but 0.7 or less.

2. The ink according to claim 1,
wherein the wax comprises a polyethylene wax.

3. The ink according to claim 1,
wherein the urethane resin particles comprise polycarbonate urethane resin particles.

4. The ink according to claim 1,
wherein the urethane resin particles have a Martens hardness of 10 N/mm² or less.

5. The ink according to claim 1,
wherein the acrylic resin particles comprise acrylic silicone resin particles.

6. The ink according to claim 1,
wherein a ratio by mass (the resin particles/the coloring material) of a proportion (percent by mass) of the resin particles to a proportion (percent by mass) of the coloring material is 0.5 or greater but 3.0 or less.

7. The ink according to claim 1,
wherein a proportion of the wax as expressed in a solid proportion is 0.09 percent by mass or greater but 0.5 percent by mass or less.

8. The ink according to claim 1,
to wherein a total Hansen solubility parameter of the organic solvent is 20 MPa^{1/2} or greater but 23 MPa^{1/2} or less.

9. The ink according to claim 1,
wherein the organic solvent comprises at least one selected from the group consisting of 3-butoxy-N,N-dimethylpropionamide, 3-methoxy-N,N-dimethylpropionamide, 3-ethyl-3-hydroxymethyloxetane, propylene glycol monopropyl ether, and propylene glycol monomethyl ether.

10. The ink according to claim 9,
wherein the organic solvent comprises an amide solvent which is at least one of 3-butoxy-N,N-dimethylpropionamide and
3-methoxy-N,N-dimethylpropionamide, and
wherein a ratio by mass (the amide solvent/the urethane resin particles) of a proportion (percent by mass) of the amide solvent to the proportion (percent by mass) of the urethane resin particles is 0.1 or greater but 5.0 or less.

11. The ink according to claim 1,
wherein the resin particles have a volume average particle diameter of 10 nm or greater but 1,000 nm or less.

12. The ink according to claim 1,
wherein the proportion of the acrylic resin particles is 6 percent by mass or greater but 20 percent by mass or less.

13. The ink according to claim 1,
wherein the proportion of the urethane resin particles is 1 percent by mass or greater but 4 percent by mass or less.

14. The ink according to claim 1,
wherein a proportion of the organic solvent is 10 percent by mass or greater but 60 percent by mass or less.

15. The ink according to claim 1,
wherein a proportion of the coloring material is 1 percent by mass or greater but 15 percent by mass or less.

16. An ink comprising:
an organic solvent;
water; and
a coloring material,
wherein an ink film formed with the ink gives an area ratio (B/A) of 0.3 or greater but 1.0 or less when measured according to a Fourier transform infrared spectroscopy method, where A in the area ratio (B/A) is an area of a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less, and B in the area ratio (B/A) is an area of a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less, and
wherein an ink film in which the ink is attached in an amount of 1.12 mg/cm² has a dynamic friction coefficient of 0.4 or less.

17. An ink stored container comprising:
the ink according to claim 1; and
a container storing the ink.

18. An inkjet printing method comprising
applying a stimulus to the ink according to claim 1 to discharge the ink to print an image on a print medium.

19. An inkjet printing apparatus comprising
an ink discharging unit configured to apply a stimulus to the ink according to claim 1 to discharge the ink to print an image on a print medium.

20. A printed matter comprising:
a print medium; and
an ink film on the print medium,
wherein the ink film comprises an organic solvent and a coloring material, wherein the ink film gives an area ratio (B/A) of 0.3 or greater but 1.0 or less when measured according to a Fourier transform infrared spectroscopy method, where A in the area ratio (B/A) is an area of a peak region enclosed by a spectral region of from 692 cm⁻¹ through 707 cm⁻¹ and a tangent line connecting a minimum point in a spectral region of 710 cm⁻¹ or greater but 740 cm⁻¹ or less with a minimum point in a spectral region of 660 cm⁻¹ or greater but 690 cm⁻¹ or less, and B in the area ratio (B/A) is an area of a peak region enclosed by a spectral region of from 1,731 cm⁻¹ through 1,750 cm⁻¹ and a tangent line connecting a minimum point in a spectral region of 1,660 cm⁻¹ or greater but 1,690 cm⁻¹ or less with a minimum point in a spectral region of 1,760 cm⁻¹ or greater but 1,790 cm⁻¹ or less, and
wherein the ink film has a dynamic friction coefficient of 0.4 or less.
